(19) United States
(12) Patent Application Publication
(10) Pub. No.: US 2015/0006618 A9
(43) Pub. Date: Jan. 1, 2015

(54) SYSTEM AND METHOD FOR PROVIDING MATCHED MULTIMEDIA VIDEO CONTENT

(71) Applicants: Robert Bryce Clemmer, Portland, OR (US); Sam Olusegun Oluwalana, Cupertino, CA (US); Elliot Allen Swan, Portland, OR (US); Mathew David Polzin, Portland, OR (US); Justin David Dunlap, Denair, CA (US)

(72) Inventors: Robert Bryce Clemmer, Portland, OR (US); Sam Olusegun Oluwalana, Cupertino, CA (US); Elliot Allen Swan, Portland, OR (US); Mathew David Polzin, Portland, OR (US); Justin David Dunlap, Denair, CA (US)

(21) Appl. No.: 14/133,583

(22) Filed: Dec. 18, 2013

Related U.S. Application Data
(63) Continuation-in-part of application No. 13/279,024, filed on Oct. 21, 2011.
(60) Provisional application No. 61/738,526, filed on Dec. 18, 2012.
(60) Provisional application No. 61/533,028, filed on Sep. 9, 2011.
(60) Provisional application No. 61/533,034, filed on Sep. 9, 2011.

(51) Int. Cl. H04L 29/06

(52) U.S. Cl. CPC H04L 67/42
USPC 709/203

(57) ABSTRACT

A system for providing content to client computing devices. The system is configured to receive an audio feed that includes audio segments. Each audio segment includes either regular audio content or preemptory audio content. The system may determine whether each audio segment includes regular or preemptory audio content. For each audio segment determined to include preemptory audio content, the system may direct the client computing devices to preempt, with the preemptory audio content, any current content being presented by the client computing devices. For each audio segment determined to include regular audio content, the system may identify the regular audio content, match multimedia video content with the identified regular audio content, and direct the matched multimedia video content to the client computing devices for presentation thereby to users.

### CROSS REFERENCE TO RELATED APPLICATION(S)

This application claims the benefit of U.S. Provisional Application No. 61/738,526, filed on Dec. 18, 2012, which is incorporated herein by reference in its entirety.

### BACKGROUND OF THE INVENTION

1. Field of the Invention

The technical field of this disclosure is video content distribution, particularly, systems and methods for providing matched multimedia video content.

2. Description of the Related Art

Audio broadcasts, whether broadcast over the air (radio or satellite broadcasts) or over the internet, may include video broadcast. However, such video broadcasts generally follow a predetermined video playlist that bears little or no relation to the audio broadcast.

A music video may be created (as a related or associated work) for an audio recording of a song or piece of music. An example of a music video is the music video created for the song “Thriller” recorded by Michael Jackson. The “Thriller” music video is an example of a music video that is longer than its associated audio recording. Sometimes more than one music video may be created for a particular song. Often (although not always), a music video depicts one or more artist who performed the song on the audio recording.

Unfortunately, it is difficult to match live on-air audio broadcasts (e.g., music and songs) with related video broadcasts (e.g., music videos). This is especially true as various music and songs have different play lengths, which also can vary from the length of related videos. Such related videos are often longer than the associated audio recording. Further, the music and songs may be interrupted as a disc jockey (“DJ”) changes the song, talks, or airs a commercial. Live content can be, but not limited to, programmed content or content that is streamed in real time as it happens, provided by a content provider or partner via a forward-only stream.

Therefore, a need exists for methods of matching and/or syncing live audio content (e.g., a DJ playing recorded audio content) with related matched multimedia video content (e.g., music videos created for the audio content played by the DJ) so that the matched multimedia video content may be broadcast to users. The present application provides these and other advantages as will be apparent from the following detailed description and accompanying figures.

### SUMMARY OF THE INVENTION

Embodiments include a method of providing content to a client computing device configured to present the content to a user. The method is performed by one or more computing devices connected to the client computing device. The method includes receiving an audio feed having audio segments. Each of the audio segments includes either regular audio content or preemptory audio content. The method further includes determining whether each of the audio segments includes regular audio content or preemptory audio content. For audio segment determined to include preemptory audio content, the client computing device is directed to preempt, with the preemptory audio content, any current content being presented by the client computing device. For each of the audio segments determined to include regular audio content, the method includes identifying the regular audio content, matching multimedia video content with the identified regular audio content, and directing the matched multimedia video content to the client computing device for presentation thereby to the user.

Whether each of the audio segments includes regular audio content or preemptory audio content may be determined by (a) attempting to identify audio content included in the audio segment, and (b) determining the audio segment includes preemptory audio content if the attempt to identify the audio content is unsuccessful. Alternatively, if the audio feed is received from an audio source, whether each of the audio segments includes regular audio content or preemptory audio content may be determined by receiving an indicator from the audio source indicating whether the audio segment includes regular audio content or preemptory audio content.

Identifying the regular audio content may include parsing meta data from the regular audio content, and optionally disambiguating that meta data to obtain a unique representation of the regular audio content. An audio object (e.g., song) may be identified by searching an audio database for the unique representation of the regular audio content. The multimedia video content may be matched with the identified regular audio content by searching a video storage for one or more multimedia video content objects that match the audio object, wherein the one or more multimedia video content objects include the multimedia video content. Optionally, the one or more multimedia video content objects may be filtered to obtain the multimedia video content. Optionally, a weight may be assigned to each of the one or more multimedia video content objects, and one of the one or more multimedia video content objects selected as the multimedia video content based on the weight assigned to each of the one or more multimedia video content objects. The weight assigned to each of the one or more multimedia video content objects may be determined at least in part based on user feedback.

The audio feed may be received from a radio station. In such embodiments, the regular audio content may be identified by receiving identifying information from the radio station, or parsing now playing information provided by a secondary source that is time synced with the audio feed.

Alternatively, the regular audio content may be identified by performing a fingerprinting operation on the regular audio content. The fingerprinting operation may include performing a Sim-Hash algorithm on the regular audio content.

When the matched multimedia video content is explicit content, the method may include requiring a confirmation from the client computing device before directing the matched multimedia video content to the client computing device.

Embodiments include a system for use with a plurality of client computing devices each configured to display audio and video content. The system includes at least one update server computing device configured to receive an audio feed comprising audio segments, match at least a portion of the audio segments with video content, and construct an update for each of the audio segments. Each update includes the video content, if any, matched with the audio segment associated with the update. The system also includes at least one communication server computing device connected to the plurality of client computing devices and the at least one update server computing device. The at least one communication server computing device is configured to receive the updates, and direct the updates to the plurality of client computing devices. The at least one communication server computing device may include a plurality of communication server computing devices. In such embodiments, the system may include at least one long poll redirect server computing device configured to receive long poll requests (indicating that the client computing devices would like to continue receiving updates) from the plurality of client computing devices, and direct each of the requests to a selected one of the plurality of communication server computing devices.

Embodiments include a method for use with a server computing device and an audio stream received by the server computing device. The method includes playing, by a client computing device connected to the server computing device, current content comprising either current video content or current audio only content. While the current content is playing, the client computing device receives a first update from the server. The first update indicates whether first video content has been matched to first audio content in the audio stream. When the first update indicates that first video content has been matched to the first audio content, the client computing device determines whether to preempt the current content with the first video content or wait to play the first video content until after the current content has finished playing.

Optionally, when the first update indicates that first video content has not been matched to the first audio content, the client computing device selects a live content stream comprising live content, and plays the live content of the live content stream.

Optionally, after starting to play the live content, the client computing device receives a second update from the server, and preempts the live content with the second video content. In such embodiments, the second update indicates a second video content has been matched to second audio content in the audio stream.

Optionally, while playing the first video content, the client computing device receives a second update from the server, and waits to play the second video content until after the first video content has finished playing. In such embodiments, the second update indicates a second video content has been matched to second audio content in the audio stream.

Optionally, while playing the first video content, the client computing device receives a second update from the server, and preempts the first video content with the second audio content. In such embodiments, the second update indicates a second video content has not been matched to second audio content in the audio stream. The second audio content may be a commercial.

Optionally, the client computing device may receive an indication that a first user operating the client computing device would like to share the first video content with a second user operating a different client computing device. When this occurs, a link to the first video content is sent to the different client computing device that when selected by the second user causes the different computing device to play the first video content and begin receiving updates from the server computing device based on the audio feed.

### BRIEF DESCRIPTION OF THE SEVERAL VIEWS OF THE DRAWING(S)

FIG. 1 is a block diagram of a system configured to provide matched multimedia video content to clients for presentation thereby to listeners/viewers.

FIG. 2 is a client display screen configured to be displayed by one or more of the clients depicted in FIG. 1.

FIGS. 3A & 3B are a flowchart of a first method of providing matched multimedia video content that may be performed by the system of FIG. 1.

FIG. 4 is a flowchart of a second method of providing matched multimedia video content that may be performed by the system of FIG. 1

FIGS. 5A-5C are timing charts for queues at each of the clients used to present matched multimedia video content to viewers/listeners.

FIG. 6 is a block diagram of a system that may be used to implement a server of the system of FIG. 1.

FIG. 7 is a diagram of a hardware environment and an operating environment in which the computing devices of the systems of FIGS. 1 and 6 may be implemented.

Throughout the various figures, like reference numbers refer to like elements.

### DETAILED DESCRIPTION OF THE INVENTION

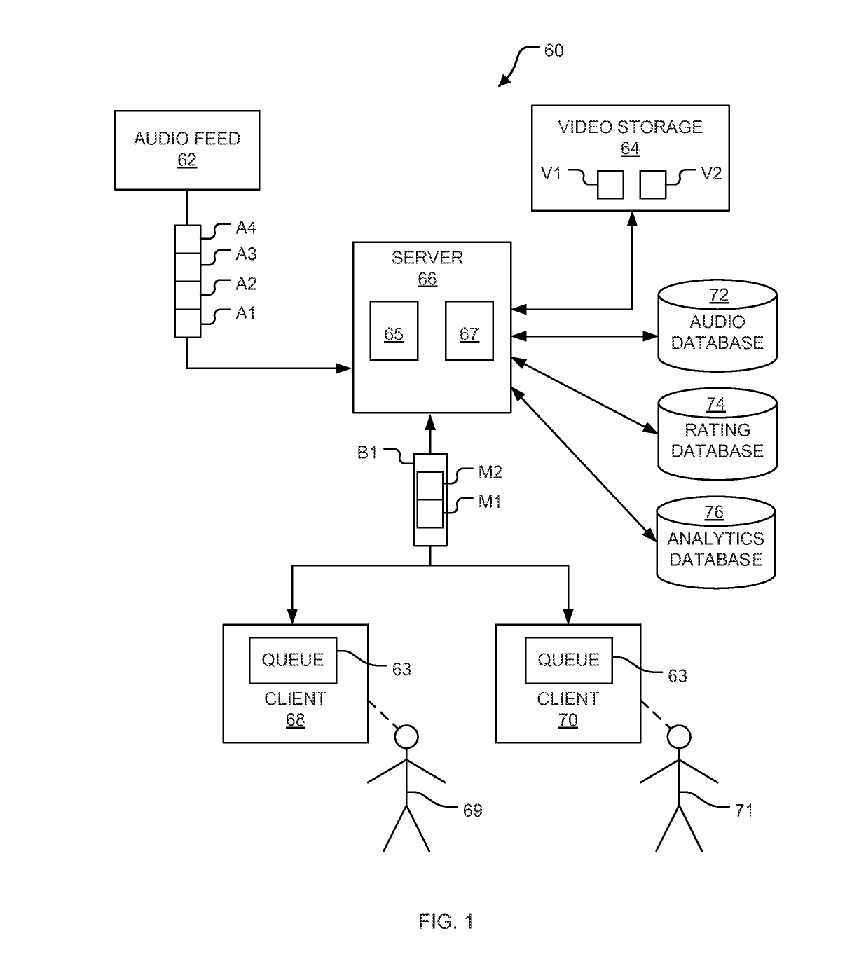

FIG. 1 is a block diagram of a system, generally designated 60, for providing matched multimedia video content to clients 68, 70, where video content is seamlessly matched and/or synced with live on-air music or songs (e.g., broadcast by an online radio station). Embodiments of the system 60 may make radio, along with any other audio, more engaging and marketable. This technology enables artists, radio stations, and record labels to match and/or sync the video content to the audio content. As mentioned above, a music video may be created (as a related or associated work) for an audio recording of a song or piece of music. Thus, the audio content may include an audio recording of a song and/or music, and the video content may include a music video created for the audio recording.

One or more embodiments of the system 60 matches and/or syncs video content with audio content being played by an audio source (e.g., a radio station broadcast or an internet audio stream). The audio content may be included in an audio feed 62. Further, the audio content may be characterized as including a plurality of audio segments “A1” to “A4.” Each segment may be either regular audio content (e.g., an audio recording of a song), or preemptory audio content (e.g., a commercial).

The audio segments “A1” to “A4” may alternate (or switch back and forth) between regular and preemptory audio content. In at least one embodiment, the video content is cut off or paused immediately when the audio content is changed or stopped, by a DJ for example.

As mentioned above, matching audio and video content may have different lengths (or durations). The system 60 may be configured to track the audio content by placing audio segments in a queue 63 at each the clients 68, 70. This enables the music videos to be played in full form while still being matched and/or synced with the audio feed 62. In at least one embodiment, a matched or synched audio video broadcast “B1” is controlled by the length of the audio content, while in at least one other embodiment, the length of the matched or synched audio video broadcast “B1” is controlled by the length of the video content.

To match video content with the audio content included in the audio feed 62, the system 60 may detect (or identifies) which song is playing by (1) parsing meta data out of the stream itself, this is possible due to the encoding of the stream, and/or (2) by getting information directly or indirectly from audio sources (e.g., radio stations), this includes being directly linked to the audio sources' (e.g., radio stations') automation system or by parsing updates received from their sites. Methods for obtaining the meta data from the audio stream are not limited to what is presented here. For example, the actual sound waves could be recognized and converted to meta data through a process of fingerprinting the beginning seconds of each song expected to be seen and comparing them directly to the bytes of the audio stream, for example.

If the system 60 receives data that includes errors such as misspellings, grammar, etc., the system 60 may correct the data via multiple methods. For example, the system may index, and continue to index, all songs that have been produced in such a way that misspellings are ignored. The system 60 tokenizes the data so that grammar and order are less of a concern, and removes extraneous information in order to yield a singular (unique) song representation. To get such an index, the system 60 can take songs that have been produced and remove near duplicates through a process of fingerprinting that yields similar or identical fingerprints when the data is only slightly different, this process is called the Sim-Hash algorithm. After building the index of unique songs, the system 60 can query the index for song representations regardless of typographic errors and misspellings. This index also stores phonetic representations of each of the song titles, artists, etc. Once incoming meta data is resolved to a unique song item, the system 60 can proceed without worrying about erroneous data.

FIG. 1 is a high level view of the system 60. The system 60 includes one or more servers (e.g., server 66) configured to provide the live broadcast “B1” to clients 68, 70, which are accessible to listeners/viewers 69, 71 for listening to and/or viewing the broadcast “B1.” The server 66 may be connected to and/or implement one or more databases. In the embodiment illustrated, the server 66 is connected to an audio database 72, a content rating database 74, and an analytics database 76. The server 66 is configured to receive one or more audio feeds (e.g., the audio feed 62). The audio feed 62 may include a first audio content (e.g., the first audio segment “A1”) for example. The server 66 accesses a video storage 64, and determines (or identifies) at least one video content that matches the first audio content (e.g., the first audio segment “A1”). The identified video content may be a first video content “V1” for example. Those of ordinary skill in the art will appreciate that, while the video storage 64 is illustrated as a separate, stand-alone device, embodiments are contemplated in which the video storage 64 is incorporated into the one or more servers (e.g., the server 66). The server 66 includes a processor 65 and a memory 67 coupled to the processor 65. The memory 67 contains programming code to carry out the methods discussed herein. By way of a non-limiting example, the server 66 may be implemented by a computing device 12 (see FIG. 7) described below.

The server 66 matches and/or syncs the first video content “V1” with the first audio content (e.g., the first audio segment “A1”) in real time, forming matched first audio/video content “M1,” and provides the matched first audio/video content “M1” in the live broadcast “B1” to the one or more clients 68, 70 accessible to the listeners/viewers 69, 71. The matched first audio/video content “M1” may include the first video content “V1” and/or the first audio content (e.g., the first audio segment “A1”). If the broadcast “B1” is intended to play music videos associated with the audio content included in the audio feed 62, the matched first audio/video content “M1” may include the first video content “V1,” and omit the first audio content.

The clients 68, 70 may be implemented using any device on which the listeners/viewers 69, 71 can receive a broadcast (e.g., the live broadcast “B1”), including exemplary devices such as personal computers (PC's), cable TVs, PDA's, cell phones, automobile radios, portable radios, and the like. The clients 68, 70 can include any sort of user interface, such as audio, video, or the like, which makes the broadcast “B1” perceivable by the listeners/viewers 69, 71. By way of a non-limiting example, the each of the clients 68, 70 may be implemented by the computing device 12 (see FIG. 7) described below.

The audio feed 62 may include a second audio content (e.g., the second audio segment “A2”). In such embodiments, the server 66 is further configured to receive the second audio content (e.g., the second audio segment “A2”). The server 66 accesses the video storage 64, and determines (or identifies) at least one video content that matches the second audio content (e.g., the second audio segment “A2”). The identified video content may be a second video content “V2” for example. The server 66 matches and/or syncs the second video content “V2” with the second audio content (e.g., the second audio segment “A2”) in real time, forming a matched second audio/video content “M2,” and provides the matched second audio/video content “M2” in the live broadcast “B1” to the one or more clients 68, 70 accessible to the listeners/viewers 69, 71. The matched second audio/video content “M2” may include the second video content “V2” and/or the second audio content (e.g., the second audio segment “A2”).

While only the first audio content (e.g., the first audio segment “A1”), the second audio content (e.g., the second audio segment “A2”), the first video content “V1,” the second video content “V2,” the matched first audio/video content “M1,” and the matched second audio/video content “M2” are discussed above, those of ordinary skill in the art will appreciate that any number of audio, video, and matched audio/video content are contemplated.

As is apparent to those of ordinary skill in the art, the first and second audio content may be the first and second audio segments “A1” and “A2,” which may each be either regular audio content or preemptory audio content.

The server 66 may be unable to match video content to some audio segments. For example, matching video content may not be available for some preemptory audio content. When this occurs, the audio content may be included in the broadcast “B1,” instead of matched audio/video content. Alternatively, predetermined or default video content may be matched with the audio content. By way of a non-limiting example, live video footage of the DJ may be matched to the audio content.

Embodiments of the system 60 further include interrupting the matched first audio/video content “M1” in the live broadcast “B1” to provide the matched second audio/video content “M2” in the live broadcast “B1.” For example, it may be desirable to interrupt the matched first audio/video content “M1” in this manner when the second audio segment is preemptory audio content and the first audio segment is regular audio content.

The system 60 may include providing the live broadcast “B1” over the air or on an internet based stream. Embodiments of the system 60 further include queuing the matched second audio/video content “M2,” where the matched first audio/video content “M1” in the live broadcast “B1” is tracked, and providing the queued matched second audio/video content “M2” after the matched first audio/video content “M1” is broadcast in the live broadcast.

The clients 68, 70 may each receive the audio feed 62. As will be explained below, the broadcast “B1” may include a series of updates sent to the clients 68, 70. An update indicates whether video content is to be played. If the update indicates that video content is to be played, the update includes the video content. On the other hand, if the update indicates that video content is not to be played, the clients 68, 70 may select a live content stream (e.g., the audio feed 62) to play, or play other content (e.g., queued content). If an update includes video content to be played, the clients 68, 70 receiving the update may play the video content. On the other hand, if an update does not include video content, the clients 68, 70 receiving the update may play the audio feed 62. While video content is playing, the audio feed 62 may be muted or turned off. Alternatively, the audio feed 62 may be queued in the queue 63. As updates including video content are received, the video content may be played immediately or queued in the queue 63.

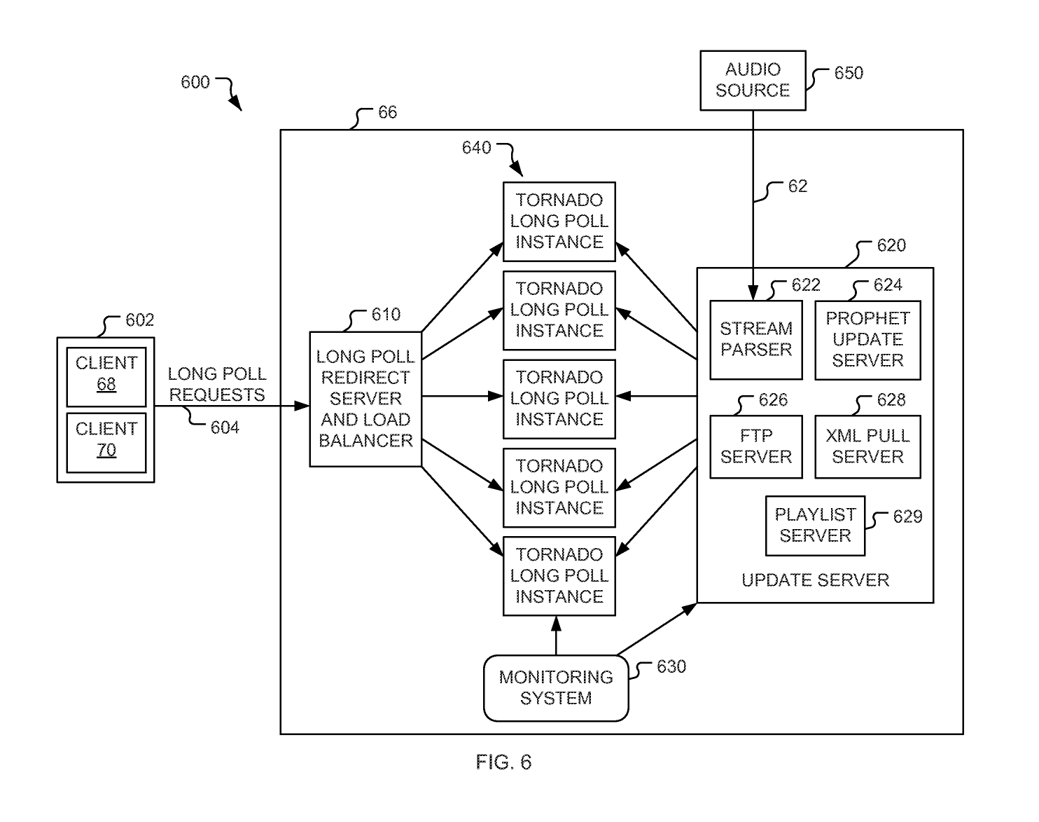

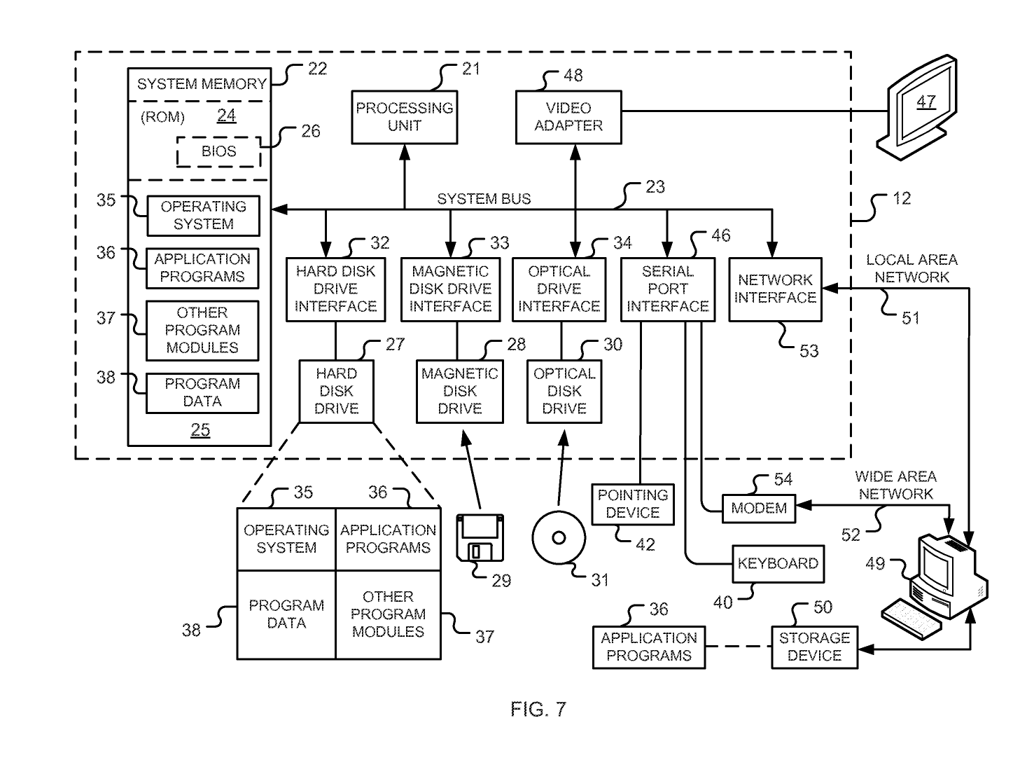

By way of a non-limiting example, the audio feed 62 may include an audio recording (or audio version) of a song (e.g., a currently playing song). In this example, the first audio segment “A1” is the audio version of the song. The server 66 accesses the video storage 64, and identifies the first video content “V1” that matches the first audio segment “A1.” For example, the server 66 may query the video storage 64 (e.g., YouTube) using meta data received from the audio source (e.g., the radio station depicted in FIG. 6) or obtained from the first audio segment “A1.” If multiple videos are returned in response to the query, the server 66 may select one of those videos as the first video content “V1.” In this example, the first video content “V1” is a video recorded for (or a video version of) the song. Thus, in this example, the matched first audio/video content “M1” pairs together the audio and video versions of the song. When the video version of the currently-playing song is longer than the audio version (of the same song) playing within the audio feed (or stream) 62, a next update will come in from one of the long poll server instances (e.g., one of the long poll tornado server instances 640 illustrated in FIG. 6), described below, before the video is finished playing. In some embodiments, when one of the clients 68, 70 gets a video update while another video is playing, it can simply add it to the play queue 63. When the client gets an audio update (such as a commercial break) while a video is playing, it can buffer the streaming audio in memory while the video continues to play so that when the video finishes playing, the audio can be played from the time the update came in even though the audio segment is already done playing or part way through playing on the live audio stream. This behavior applies to streaming video as well.

Live audio content refers to content included in the audio feed 62. On-demand content refers to matched audio/video content. Live video is implemented in much the same way that live audio is implemented. A content provider provides a live (time-specific, forward-only) video stream in a format such as Hypertext Transfer Protocol (“HTTP”) Live Streaming (“HLS”), Flash Video (“FLV”)/Real Time Messaging Protocol (“RTMP”), or a pseudo-streaming format. When an update comes in from one of the long poll server instances (e.g., one of the long poll tornado server 640 illustrated in FIG. 6) indicating that a live video segment is being streamed (such as a DJ break, an event or show, a video ad, etc.), the client (e.g., one of the clients 68, 70), in various embodiments, can play, queue, or show a thumbnail of the relevant live video stream, following an Update Handling Sequence.

In an embodiment, an Update Handling Sequence is as follows:
When an update comes in from one of the long poll server instances (e.g., one of the long poll tornado server instances 640 illustrated in FIG. 6), the client (e.g., one of the clients 68, 70) checks to see if on-demand content (such as a video) has been matched to the update by the server 66.
If on-demand content is available, it is either added to the play queue 63 (if other on-demand or queued live content is playing) or played right away (if non-queued live content is playing).
If on-demand content is not available, the client picks the most preferred live content stream based on the play mode, the user agent type and capabilities, and/or other criteria. It then either plays the live content in a muted state as a thumbnail in the client user interface (“UI”) or turns the live content off (if the live content contains video and the server 66 indicates that it is real time streaming content), queues the live content (if on-demand or queued live content is playing and the platform or user agent supports queuing of live content), or interrupts the currently playing content and plays the live content (if no on-demand content is playing, the client does not support queuing, or the server sets a parameter indicating that the live content should be forced to play).

When on-demand or queued live content finishes playing, the client determines if other on-demand or queued live content is on the queue. If so, the earliest queued on-demand or queued live content item in the queue is played. If not, the client selects and plays the best live content stream from the streams specified in the latest update from the long poll server based on the play mode, the user agent type and capabilities, and/or other criteria.

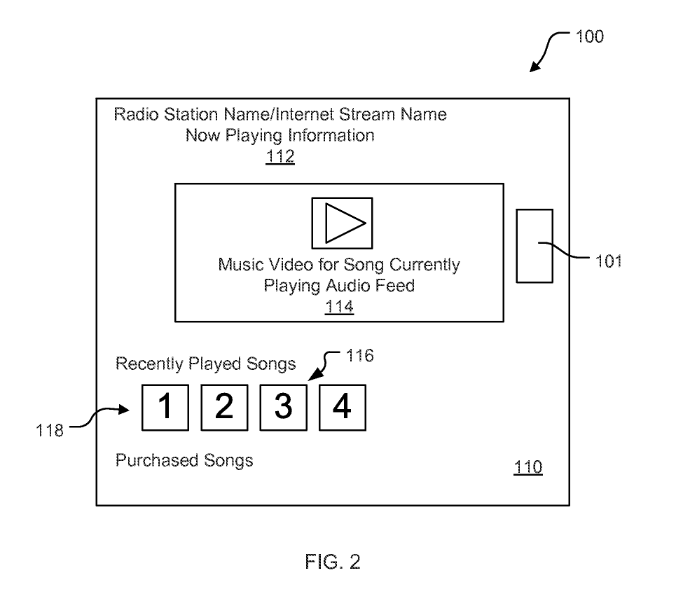

FIG. 2 is a client display screen that may be displayed by each of the clients 68, 70. The client display screen illustrated in FIG. 2 is implemented as an exemplary webpage, generally designated 100.

Referring to FIG. 2, the webpage 100 can be part of a client presenting content, such as preemptory audio content or matched multimedia video content, to a listener/viewer. The webpage 100 includes a screen portion 110 including an ID portion 112 that identifies an audio source (e.g., a radio station/internet stream name). The screen portion 110 further includes a media player portion 114 that provides (or displays) the music video for the song currently playing in the audio feed 62. The webpage 100 can include one or more selection buttons 116 arranged in a client user interface portion 118 that identify recently played songs and/or upcoming songs. In one embodiment, the selection buttons 116 allow the listener/viewer to purchase recently played songs. For example, one of the selection buttons 116 may direct the listener/viewer to an external content source or provider (e.g., iTunes) to purchase the song. In another embodiment, clicking on one of the selection buttons 116 plays the associated video in the media player portion 114 of the webpage 100, then returning to preemptory audio content or matched multimedia video content and the associated video ends. The webpage 100 can also include a share button 101 associated with a video from the matched multimedia video content displayed to a listener/viewer at a first client. Clicking on the associated share button at the first client sends a link to a second client, at which clicking on the link plays the same video at that second client. When the video ends at the second client, the second client receives preemptory audio content or matched multimedia video content from the audio source (e.g., radio station) originally providing the video to the first client.

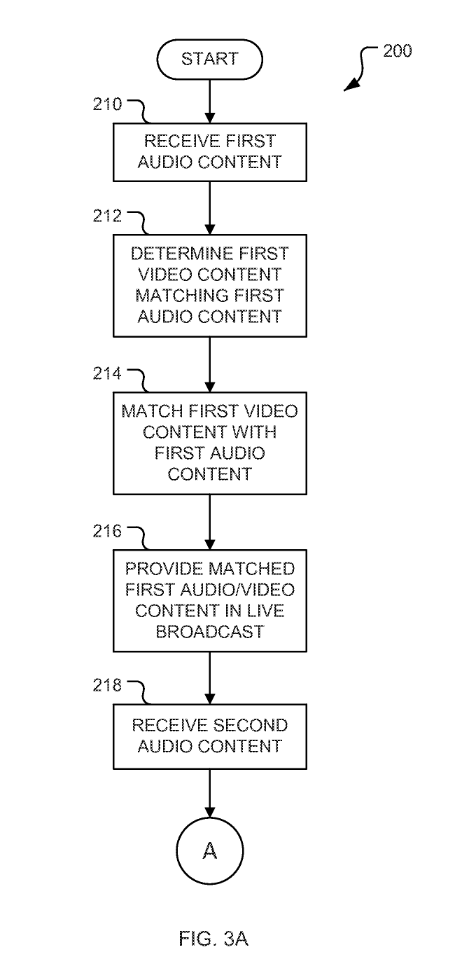

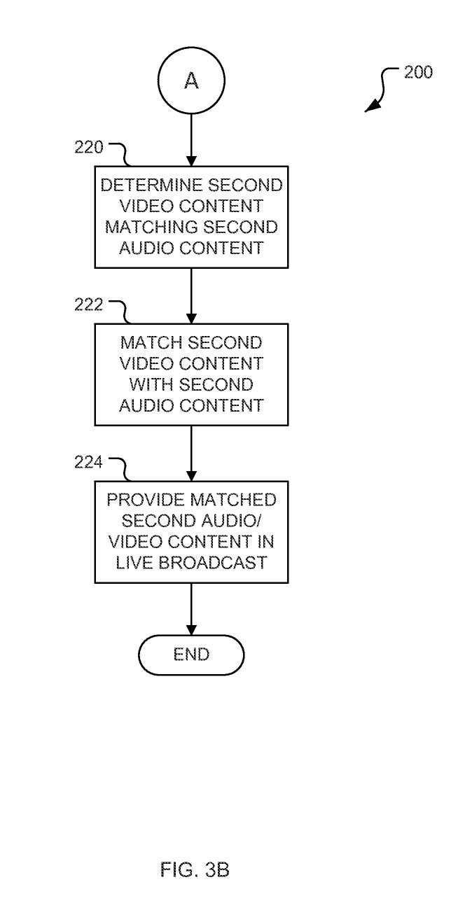

FIGS. 3A & 3B depict a high level flow chart illustrating a method, generally designed 200, for matching audio and video content, and providing a live broadcast. The method 200 may be performed by the system 60. For ease of illustration, the method 200 will be described as being performed by the server 66. In block 210, the server 66 receives one or more audio content. For ease of illustration, in block 210, the server 66 receives the first audio content (e.g., the first audio segment “A1”). In next block 212, the server 66 determines (or identifies) one or more video content (e.g., the first video content “V1”) that matches and/or syncs with the first audio content (e.g., the first audio segment “A1”). In block 214, the server 66 matches the first video content “V1” with the first audio content (e.g., the first audio segment “A1”) in real time, forming the matched first audio/video content “M1.” In block 216, the server 66 provides (or includes) the matched first audio/video content “M1” in the live broadcast “B1” sent to the clients 68, 70. For example, the server 66 may send a first update to the clients 68, 70 that includes the first video content “V1.”

In block 218, the server 66 receives one or more audio content (e.g., the second audio content). In block 220, the server 66 determines (or identifies) one or more video content (e.g., the second video content “V2”) that matches and/or syncs with the second audio content (e.g., the second audio segment “A2”). In block 222, in real time, the server 66 forms the matched second audio/video content “M2.” In block 224, the server 66 provides (or includes) the matched second audio/video content “M2” in the live broadcast “B1” sent to the clients 68, 70. For example, the server 66 may send a second update to the clients 68, 70 that includes the second video content “V2.”

Embodiments of the method 200 further include interrupting the matched first audio/video content “M1” provided in the live broadcast “B1” to provide the matched second audio/video content “M2” in the live broadcast. The method 200 may include providing the live broadcast “B1” over the air or on an internet based stream. Embodiments of the method 200 further include queuing the matched second audio/video content “M2,” where the matched first audio/video content “M1” in the live broadcast is tracked and providing the queued matched second audio/video content “M2” after the matched first audio/video is broadcast “M1” in the live broadcast “B1”.

Still another embodiment relates to a device (e.g., the server 66) including one or more memory devices (e.g., the video storage 64) configured to store a plurality of video content (e.g., the first and second video content “V1” and “V2”) and one or more processors (e.g., the processor 65) operably coupled to the one or more memory devices. The one or more processors are configured to receive one or more audio content (e.g., the first audio content “A1”), a first audio content for example; determine at least one video content (e.g., the first video content “V1”), first video content for example, from the plurality of video content that matches the first audio content; match and/or sync the first video content with the first audio content in real time, forming matched first audio/video content (e.g., the matched first audio/video content “M1”); and provide the matched first audio/video content in the live broadcast “B1.” The one or more processors are further configured to receive one or more additional audio content (e.g., the second audio content “A2”), a second audio content for example; determine at least one video content (e.g., the second video content “V2”), a second video content for example, from the plurality of video content that matches the second audio content; match and/or sync the second video content with the second audio content in real time, forming matched second audio/video content (e.g., the matched second audio/video content “M2”); and provide the matched second audio/video content in the live broadcast.

Embodiments of the device further include interrupting the provided matched first audio/video content in the live broadcast to provide the matched second audio/video content in the live broadcast. The device may include providing the live broadcast over the air or on an internet based stream. Embodiments of the device further include queuing the matched second audio/video content, where the matched first audio/video content in the live broadcast is tracked and providing the queued matched second audio/video content after the matched first audio/video is broadcast in the live broadcast.

One or more embodiments relate to a computer program product including a computer readable medium having computer readable instructions for providing a live broadcast. The computer readable instructions are configured to receive one or more audio content (e.g., the first audio content “A1”), a first audio content for example; determine at least one video content (e.g., the first video content “V1”), a first video content for example, that matches the first audio content; match and/or sync the first video content with the first audio content in real time, forming matched first audio/video content (e.g., the matched first audio/video content “M1”) and provide the matched first audio/video content in the live broadcast. The computer readable instructions are further configured to receive one or more audio content (e.g., the second audio content “A2”), a second audio content for example; determine at least one video content (e.g., the second video content “V2”), a second video content for example, that matches the second audio content; match and/or sync the second video content with the second audio content in real time, forming matched second audio/video content (e.g., the matched second audio/video content “M2”); and provide the matched second audio/video content in the live broadcast.

Embodiments of the computer program product further include interrupting the provided matched first audio/video content in the live broadcast to provide the matched second audio/video content in the live broadcast. The computer program product may include providing the live broadcast over the air or on an internet based stream. Embodiments of the computer program product further include queuing the matched second audio/video content, where the matched first audio/video content in the live broadcast is tracked and providing the queued matched second audio/video content after the matched first audio/video is broadcast in the live broadcast.

Furthermore, the server 66 may use a process to match video content to the currently playing audio content that can be summarized as follows:

1. First, the audio content is distilled into a concise piece of meta data that represents the currently airing item. This consists of a) reading the audio stream directly and determining the now playing song through embedded meta data, or b) retrieving the meta data by way of parsing now playing information from a secondary source that is time synced with the audio stream, or c) receiving meta data pushed (e.g., in updates sent) directly from audio sources (e.g., pushed by radio stations via their radio automation systems).

2. Once the server 66 has the meta data, the server 66 disambiguates that meta data to render the representation of a unique song. To disambiguate the meta data, the server 66 first removes extraneous information such as featuring artists, secondary song titles, etc. Once these have been removed, the server 66 matches the meta data against the audio database 72 of all songs that have been published, which the server 66 has indexed in such a way that close matches and misspelled names and titles are ignored while matching. This is accomplished through phonetic encodings and fingerprinting on the meta data in the audio database 72 of songs.

3. Once the song object has been determined (e.g., a match has been found in the audio database 72), it is used by the server 66 to query the video data source (e.g., the video storage 64) for objects with the closest match to the song. If multiple results are returned in response to the query, the list of video objects goes through a set of filters based on video length, title, description, and other key features to determine which of the videos to display to the clients 68, 70. This filtering process may be aided by feedback from the clients 68, 70. For example, the clients 68, 70 may indicate that video paired with particular audio is sub optimal. The server 66 may store that information and use it to weigh negatively on the selected video, allowing other videos to be elevated relative to the selected video. Eventually, the process of weighting stabilizes and an optimal video is chosen over time.

FIG. 4 is a flowchart of a method 400 of providing matched multimedia video content that may be performed by the system 60. For ease of illustration, the method 400 will be described as being performed by the server 66. Referring to FIG. 4, in block 402, the server 66 receives the audio feed 62. The audio feed 62 has a plurality of audio segments. Each of the audio segments is either regular audio content, or preemptory audio content. In decision block 204, the server 66 continuously samples the audio feed 62, and determines, for each audio segment, whether the audio segment is regular audio content or preemptory audio content.

The server 66 may determine an audio segment includes preemptory audio content if the server 66 is unable to match the audio segment with video content. For example, the server 66 may be unable to identify the audio content in the audio segment. The server 66 may be unable to identify the audio content in the audio segment if the server 66 cannot find a match for the meta data associated with the audio segment (or the unique representation of the audio content) in the audio database 72. Alternatively, the server 66 may determine an audio segment includes preemptory audio content if the server 66 receives an indicator (e.g., a tag value) in meta data sent by the audio source (e.g., the radio station 650 illustrated in FIG. 6) that indicates whether the audio segment includes preemptory audio content or regular audio content. The meta data may be sent to the server 66 in an update associated with the audio segment.

When the server 66 determines (in decision block 204) the audio segment is preemptory audio content, in block 406, the server 66 directs the preemptory audio content to the clients 68, 70 to preempt any current content being presented at the clients.

On the other hand, when the server 66 determines (in decision block 204) that the audio segment is regular audio content, in block 410, the server 66 identifies the regular audio content 410. Then, in block 412, the server 66 matches multimedia video content with the identified regular audio content. In block 414, the server 66 directs the matched multimedia video content to the clients 68, 70.

The audio feed 62 can be received in block 402 from an audio source (e.g., a radio station 650 depicted in FIG. 6) directly, over a wired or wireless system, or over the Internet. The audio segments in the audio feed 62 can include live or recorded audio content. Preemptory audio content takes priority over regular audio content broadcasting to the client. A non-limiting example of regular audio content includes music audio content, such as recorded music, songs, or the like. A non-limiting example of preemptory audio content includes live feed audio content, such as an announcement from a disc jockey, an in studio performance, or the like. Another non-limiting example of preemptory audio content is commercial audio content, such as a live commercial presented by the disc jockey, a recorded commercial message, or the like.

The continuous sampling of the audio feed 62 performed in decision block 404 classifies the audio content segments to determine what priority the audio segments should have at the clients 68, 70. Such continuous sampling can be performed in any manner that results in the determination. As mentioned above, each of the audio segments belongs to only one of two possible classifications: regular audio content and preemptory audio content. By way of a non-limiting example, the continuous sampling of the audio feed 62 may include sampling metadata in each of the audio segments. The metadata can be inserted during recording of the audio content, and/or inserted when assembling the audio feed, such as when the audio feed is assembled by the audio source (e.g., the radio station 650 illustrated in FIG. 6). In another example, the continuous sampling of the audio feed 62 may include sampling information in each of the audio segments bit-by-bit. The bit pattern can be compared to known bit patterns for regular audio content, such as particular music in an audio recording. In yet another example, the continuous sampling of the audio feed 62 may include sampling predetermined scheduling information. When the audio source (e.g., the radio station 650 illustrated in FIG. 6) plans or assembles the audio feed, predetermined scheduling information can be recorded indicating when particular audio content is to be presented.

When preemptory audio content is directed to the client in block 406, the preemptory audio content preempts any current content being presented at the clients 68, 70. In other words, the preemptory audio content is given priority over any other content currently being presented at the clients 68, 70 to the listeners/viewers 69, 71. In this manner, peremptory audio content having monetary value to the audio source (e.g., the radio station 650 illustrated in FIG. 6), such as on-air commercials, or having social value, such as emergency notices, may be presented to the listeners/viewers 69, 71 immediately.

Optionally, in block 406, the server 66 can direct preemptory multimedia video content associated with the preemptory audio content to the clients 68, 70. This is particularly useful for live events in which it is desirable to broadcast multimedia video content from the audio source (e.g., the radio station 650 illustrated in FIG. 6), such as in-person artist appearances or performances.

When the server 66 determines (in decision block 204) the audio segment is regular audio content, the matched multimedia video content corresponding to the regular audio content is presented at the clients 68, 70 to the listeners/viewers 69, 71.

In block 410, the server 66 may identify regular audio content using the same methods of identification used to continuously sample the audio feed 62 in decision block 404. For example, in block 410, the server 66 may sample metadata in the audio segment, sample information in the audio segment bit-by-bit, and/or sample predetermined scheduling information supplied by the audio source (e.g., the radio station 650 illustrated in FIG. 6). Alternatively, in block 410, the server 66 can use the results themselves of the continuous sampling of the audio feed 66 obtained in block 404. For example, when the server 66 continuously samples the audio feed 62 in decision block 404 by sampling metadata in the audio segment, sampling information in the audio segment bit-by-bit, or sampling predetermined scheduling information supplied by the audio source (e.g., the radio station 650 illustrated in FIG. 6), the continuous sampling can also result in an identification of regular audio content, such as the song and/or artist of a musical selection for example. Such results can be used in identifying the regular audio content.

In some embodiments, the video data source (e.g., the video storage 64) may have multiple video items that closely match the given meta data. When this occurs, the server 66 may employ a two tier strategy. First, the server 66 can run a custom weighting algorithm that inspects the title, description, play count, and other metadata available for the video item to give it a weighted score. Then, the server 66 may select (to play) the video item with the highest weighted score. Second, the server 66 can use feedback from the clients 68, 70 to ameliorate the selection process. Using this process, after feedback is received, negative feedback is applied to the weighting of the video items. Given enough feedback, the weighting of the videos is automatically adjusted to provide better video selection in general. This process is called supervised learning using logistic regression to identify the weighting of feature sets.

Furthermore, in block 412, the server 66 matches multimedia video content with the identified regular audio content. Thus, the server 66 picks out the matched multimedia video content, such as a music video, to be presented at the clients 68, 70 to the listeners/viewers 69, 71. The matching can be tailored to the characteristics of the particular multimedia video storage, whether the multimedia video storage is an independent commercial service (such as YouTube®, VEVO®, or the like), or dedicated storage associated with the server 66. The matching performed in block 412 can include calculating a score for each of a plurality of multimedia candidates in the multimedia video storage, and selecting one of the plurality of multimedia candidates having the best score for the identified regular audio content as the matched multimedia video content. By way of a non-limiting example, a multimedia candidate may have the best score when the multimedia candidate is the most popular to a particular demographic group. The calculation can include calculating the score for each of the plurality of multimedia candidates from scoring factors such as upload date, author, rating, view count, combinations thereof, and the like. This scoring approach to the matching is useful when the multimedia video storage includes a number of multimedia candidates, such as music videos, for particular audio content such as a particular song. In one example, the multimedia video storage can be part of the YouTube® audio and video broadcasting service.

In another embodiment, the matching performed in block 412 can include selecting one of a plurality of multimedia candidates from multimedia video storage having one multimedia candidate for the identified regular audio content. This single selection approach to the matching is useful when the multimedia video storage includes a single multimedia candidate, such as one music video, for particular audio content such as a particular song. In one example, the multimedia video storage can be part of the VEVO® online entertainment service.

After the multimedia video content has been matched to the identified regular audio content, in block 414, the matched multimedia video content can be directed to the clients 68, 70 for presentation to the listeners/viewers 69, 71. The listeners/viewers 69, 71 are able to interact with the matched multimedia video content when the clients 68, 70 each includes a user interface, such as the client display screen (e.g., the webpage 100) illustrated in FIG. 2.

The method 400 can optionally include an explicit content filter that allows the listeners/viewers 69, 71 to avoid explicit matched multimedia video content if desired. For example, the method 400 can further include determining whether the matched multimedia video content is one of explicit multimedia video content and unrestricted multimedia video content. When the matched multimedia video content is the explicit multimedia video content, the method 400 may include requesting confirmation from the client before directing the matched multimedia video content to the client. In one example, the default setting is not to direct the matched multimedia video content determined to be explicit multimedia video content to the client unless confirmation is received. Whether the matched multimedia video content is explicit or unrestricted multimedia video content can be determined by comparing the matched multimedia video content to the content rating database 74 (see FIG. 1) that includes rating scores, and designating the matched multimedia video content as the explicit multimedia content video when the rating score exceeds a predetermined threshold. In one example, the content rating database 74 is an iTunes® application programming interface (“API”).

The method 400 can provide different options for handling the matched multimedia video content at the client when the matched multimedia video content is longer than the identified regular audio content by placement in a client queue. The method 400 can further include determining when the matched multimedia video content has a longer duration than the identified regular audio content. In one embodiment, block 414 may include directing the matched multimedia video content to a last position in the client queue 63 when the matched multimedia video content has a longer duration than the identified regular audio content. In another embodiment, block 414 may include directing the matched multimedia video content to a current play position in the client queue 63 when the matched multimedia video content has a longer duration than the identified regular audio content.

The method 400 can further include manipulation of the matched multimedia video content at the clients 68, 70 by the listeners/viewers 69, 71. In one embodiment, the method 400 further includes establishing, at the client, a client queue 63 of videos from the matched multimedia video content, each of the videos being associated with a selection button. This embodiment can also include the listener/viewer clicking on the associated selection button to play one of the videos at the client, and the server 66 directing either preemptory audio content or the matched multimedia video content to the client when the video ends.

In another embodiment, the method 400 can further include displaying, at the client, a video from the matched multimedia video content, the video being associated with a share button. One of the listeners/viewers 69, 71 may click on the associated share button to send a link to a second client with a second listener/viewer. The second listener/viewer may click on the link at the second client to play the video at the second client. The server 66 may direct either the preemptory audio content or the matched multimedia video content to the second client when the video ends.

The method 400 can include features to assess activities of the listeners/viewers 69, 71. In one embodiment, the method 400 can further include tracking client interaction with the matched multimedia video content. Tracking client interaction can include tracking such information as the most played on-demand songs, the most skipped songs, the most fast-forwarded songs, the time spent by a listener/viewer at the client, the number of explicit video plays, social media shares with other listeners/viewers using the share button, and the like. In one example, the tracking of client interaction can be a customize system based on an existing system such as Google® Analytics. To analyze tracked client interaction, a custom user interface displaying tracking statistics in tables and trend graphs can be made available to audio source (e.g., radio station) administrators. In one example, the user interface can be built from a Google® Analytics API. The method 400 can also maintain a database of activity at the client by IP address, tracking audio content listened to, video content viewed, and the like.

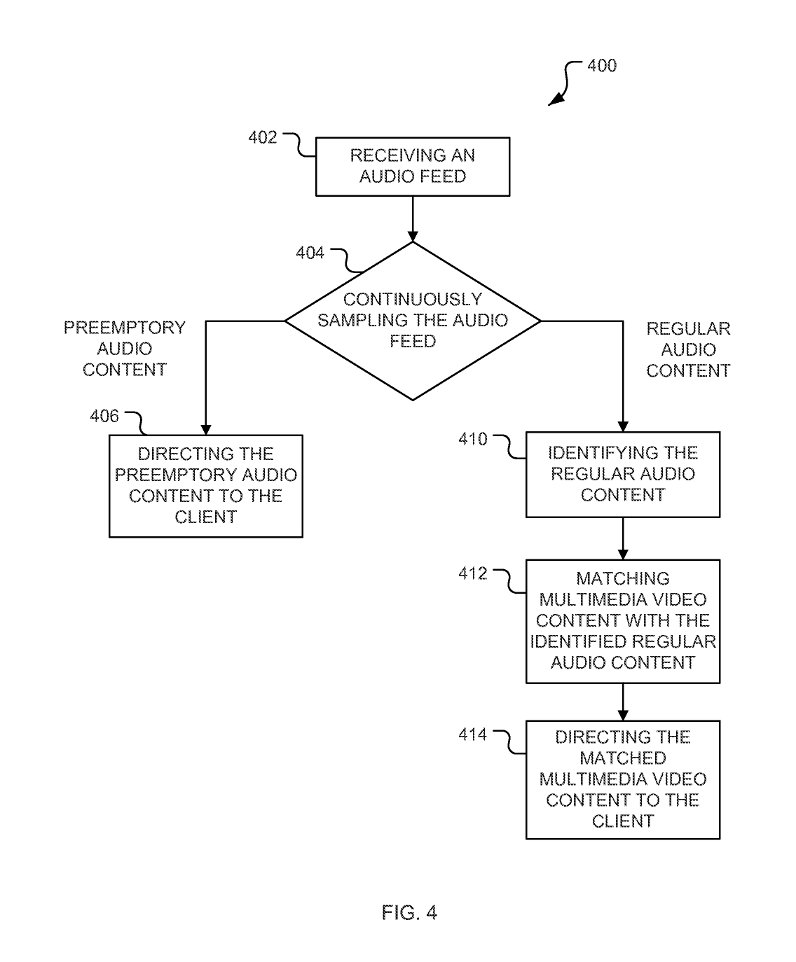

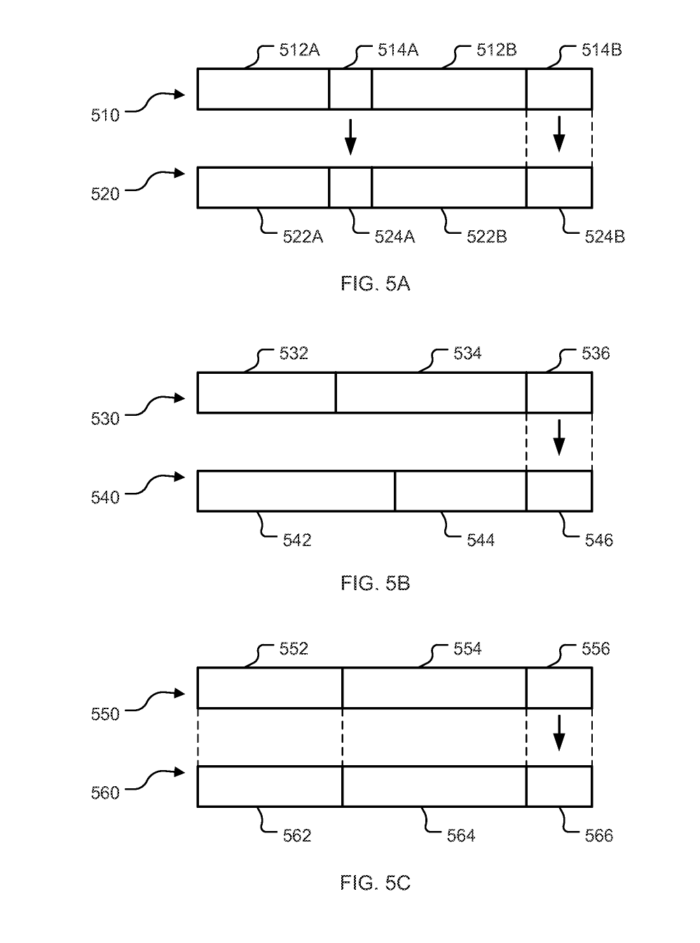

FIGS. 5A-5C are timing charts for queues at a client (e.g., one of the clients 68, 70) for a method of providing matched multimedia video content in accordance with another embodiment of the present invention. Preemptory audio content takes precedence at the client. The method can provide different options for handling the matched multimedia video content at the client when the matched multimedia video content is longer than the identified regular audio content by placement in a client queue. The client queue can be presented to the listener/viewer as a series of selection buttons on the webpage 100 displayed at the client as illustrated in FIG. 2.

FIG. 5A illustrates an audio feed providing single audio segments of regular audio content alternating with single audio segments of preemptory audio content, with truncated multimedia video content and preemptory audio content alternating at the client. Station timing diagram 510 illustrates an audio feed, such as an audio feed from an audio source (e.g., the radio station 650 illustrated in FIG. 6), having audio segments which alternate between regular audio content 512A, 512B (such as music), and preemptory audio content 514A, 514B (such as commercial audio content). Client timing diagram 520 illustrates content presented at the client to a listener/viewer. The client timing diagram 520 alternates between matched multimedia video content 522A, 522B (such as a music video), and preemptory audio content 524A, 524B (such as commercial audio content). In operation, the audio source (e.g., the radio station 650 illustrated in FIG. 6) presents an audio segment including the regular audio content 512A, which is matched with matched multimedia video content 522A, and presented at the client to the listener/viewer. When the regular audio content 512A ends and the audio source (e.g., the radio station 650 illustrated in FIG. 6) presents an audio segment including preemptory audio content 514A, the presentation of the matched multimedia video content 522A is overridden and the preemptory audio content 524A is presented at the client to the listener/viewer. Optionally, the preemptory audio content 524A can be accompanied by matched multimedia video content (such as a live video feed from the audio source), which is presented at the client to the listener/viewer. The sequence begins again when the audio segment including the preemptory audio content 524A ends, and the audio source (e.g., the radio station 650 illustrated in FIG. 6) presents the next audio segment including regular audio content 512B.

FIG. 5B illustrates an audio feed providing multiple audio segments of regular audio content alternating with single audio segments of preemptory audio content, with full multimedia video content, truncated multimedia video content, and preemptory audio content at the client. FIG. 5B illustrates one option for handling matched multimedia video content at the client when the matched multimedia video content is longer in duration than the identified regular audio content. In this example, each matched multimedia video content is presented at the client before the next matched multimedia video content begins (i.e., each matched multimedia video content is stored in a last position of a client queue).

Station timing diagram 530 illustrates an audio feed, such as an audio feed from an audio source (e.g., the radio station 650 illustrated in FIG. 6), having sequential audio segments of regular audio content 532, 534 followed by an audio segment of preemptory audio content 536 (such as commercial audio content). Client timing diagram 540 illustrates content presented at the client to the listener/viewer, including sequential matched multimedia video content 542, 544 followed by preemptory audio content 546. Each sequential matched multimedia video content is directed to the last position in the client queue when the matched multimedia video content has a longer duration than the regular audio content. The sequential matched multimedia video content 542, 544 are played at the client in order (i.e., when one matched multimedia video content has played through completely, the next multimedia video content begins). When the regular audio content 532, 534 ends and the audio source (e.g., the radio station 650 illustrated in FIG. 6) presents the audio segment including preemptory audio content 536, the presentation of the matched multimedia video content is overridden and the preemptory audio content 546 is presented at the client to the listener/viewer.

FIG. 5C illustrates an audio feed providing multiple audio segments of regular audio content alternating with single audio segments of preemptory audio content, with full truncated multimedia video content, truncated multimedia video content, and preemptory audio content at the client. FIG. 5C illustrates another option for handling matched multimedia video content at the client when the matched multimedia video content is longer in duration than the identified regular audio content. In this example, each matched multimedia video content is terminated at the client when the next matched multimedia video content begins (i.e., each matched multimedia video content is played from a current play position in the client queue regardless of whether the previous multimedia video content is over).

Station timing diagram 550 illustrates an audio feed, such as an audio feed from an audio source (e.g., the radio station 650 illustrated in FIG. 6), having sequential audio segments of regular audio content 552, 554 followed by an audio segment of preemptory audio content 556 (such as commercial audio content). Client timing diagram 560 illustrates content presented at the client to the listener/viewer, including sequential matched multimedia video content 562, 564 followed by preemptory audio content 566. Each sequential matched multimedia video content is directed to a current play position in a client queue when the matched multimedia video content has a longer duration than the regular audio content. The match multimedia video content in the current play position is presented at the client immediately, regardless of whether the prior match multimedia video content has finished. When the regular audio content 552, 554 ends and the audio source (e.g., the radio station 650 illustrated in FIG. 6) presents the audio segment including preemptory audio content 556, the presentation of the matched multimedia video content is overridden and the preemptory audio content 566 is presented at the client to the listener/viewer.

FIG. 6 is a block diagram of a system 600 implementing the server 66. In FIG. 6, the server 66 is implemented using a long poll redirect server, a plurality of long poll tornado server instances, one or more update servers, and a monitoring system. For ease of illustration, the system 600 will be described as including a long poll redirect server 610, the long poll tornado server instances 640, an update server 620, and a monitoring system 630. Each of the long poll tornado server 610, the update server 620, the long poll tornado server instances 640, and the monitoring system 630 may be implemented by the computing device 12 (depicted in FIG. 7) described below.

The long poll redirect server 610 receives long poll requests 604 from the clients 602. The clients 602 may include the clients 68, 70. By way of a non-limiting example, the long poll redirect server 610 may serve more than 80,000 clients at more than 8000 requests per second with updates from the update server 620. The long poll requests indicate that the clients 602 would like to continue receiving updates. By way of a non-limiting example, each of the clients 602 may occasionally (e.g., periodically) send a long poll request to the long poll redirect server 610. The long poll redirect server 610 redirects each long poll request to one of the long poll tornado server instances 640 based on load. The long poll tornado server instance that received the request responds to the client that sent the request. The long poll tornado server 610, the update server 620, and the monitoring system 630 communicate with each other over the long poll tornado server instances 640. The long poll tornado server instances 640 may each be implemented as virtual or physical machines. In some embodiments, multiple different types of machines may be used, each having a different dedicated Internet Protocol (“IP”) address. The monitoring system 630 can also communicate directly with the update server 620. The monitoring system 630 allows additional update servers (like the update server 620) to be added to the system 600 to handle increased load.

Each of the clients 602 may run a Javascript application that long polls the long poll redirect server 610, and displays the content with which the client is updated (from one of the long poll tornado server instances 640). Each of the clients 602 may have four different operational modes:
1. Audio Only, in which only the audio stream can play;
2. Normal Queue, in which music videos are stored in a queue and then played;
3. Modified Queue, in which music videos are stored in a queue and then played, with jumps to audio commercial breaks; and
4. Live Broadcast, in which a live streaming server presents multimedia video content, such as in-studio broadcasting.

In one example, the system 600 includes a plurality of update servers (each like the update server 620). Each of the plurality of long poll tornado server instances 640 is configured to receive updates from the plurality of update servers. Each of the long poll tornado server instances 640 is designed to run a process on each core of the machine, and is designed to be delegated to by a hardware load balancer (e.g., the long poll redirect server 610). Each of the long poll tornado server instances 640 runs two tornado applications:
1. a main application, which services the clients 602 requesting data via the long poll system (e.g., the long poll redirect server 610); and
2. an application in an additional thread (one per process) that fields requests from the plurality of update servers.
   Requests from the clients 602 are designed to only access the analytics database 76 (see FIG. 1) for analytics tracking, with all other operations are performed in memory only. The analytics database 76 is used to track requests received from the clients 602. The analytics database 76 may be used to calculate one or more metrics, such as an amount of time spent by a particular one of the clients 602 on a particular stream (e.g., the audio feed 62), and other statistics.

The update server 620 may include the following controllers:
1. a stream parser 622;
2. a prophet update server 624;
3. a File Transfer Protocol (“FTP”) server 626;
4. an Extensible Markup Language (“XML”) pull server 628; and
5. a playlist server 629.
   The update server 620 can manage the long poll tornado server instances 640 and incoming change data from these controllers. The update server 620 may include a single tornado application, and run another thread that receives data from the controllers. The thread that receives updates from the controllers manages them through a pipe/queue architecture. Incoming requests to perform create, read, update, and delete (“CRUD”) operations will modify database (“DB”) structures, and then update the in-memory controllers through private pipes to each of the stream controller processes to appropriately pull and manage the given streams. Updates from the controllers enter the public queue (thread/process safe construct) to be consumed by the thread. When consumed, the thread matches the appropriate video/ad/stream (via the appropriate manager) and updates all registered servers.

The stream parser 622 manages ICY stream data, receiving the audio feed 62 having audio segments from the audio source (e.g., the radio station 650). The stream parser 622 may be configured to receive more than one audio feed. The stream parser 622 takes in a configuration for the stream (specifying delay times on the stream, and other meta data) and a uniform resource locator (“URL”) to a PLS format file or an Advanced Stream Redirector (“ASX”) format file or raw ShoutCast or IceCast stream, then parses this stream to identify the now (or currently) playing song. The stream parser 622 has two modes: (1) an unguided mode, and (2) a guided mode. In the unguided mode, the stream parser 622 reads the stream byte by byte until the now playing song can be identified. In the guided mode, the stream parser 622 reads the stream metadata bytes until a now playing change can be detected, at which time the update server 620 can be updated. In one example, the stream parser 622 switches from the unguided mode to the guided mode when there is enough information detected in the guided mode.

The prophet update server 624 may be configured to handle input from a variety of automation systems, including but not limited to, Prophet data, and SS32 data. Thus, in the embodiment illustrated in FIG. 6, the prophet update server 624 is configured to manage two types of pushed data: (1) Prophet data, and (2) SS32 data. However, the prophet update server 624 may be configurable to accept additional types of XML push feeds from other radio station automation systems. In operation, the prophet update server 624 spawns a socket server and listens for incoming data. The prophet update server 624 creates a new thread when a push stream connects and continues to listen on that socket until the remote peer closes the connection. On detecting an update, the prophet update server 624 parses the response as one of the supported types and, on match, delegates the lookup and match of the video to the parent process in the update server 620.

The playlist server 629 is configured to manage user created playlists (content that does not have associated audio), using a schedule engine similar to the one used in the XML pull server 628 (described below). The playlist server 626 can bypass the look up stage by sending back the entire video entry through the update method of the parent process.

A Stream_Controller_update_now_playing method may be implemented by the update server 620 and used (or called) by the FTP server 626, the prophet update server 624, the XML pull server 628, and/or the playlist server 629 to lookup video content based on meta data. The Stream_Controller_update_now_playing method may be accessible to the FTP server 626, the prophet update server 624, the XML pull server 628, and/or the playlist server 629 via piped interprocess communication.

The XML pull server 628 is configured to manage a pull system to retrieve data (e.g., video content) from a URL that changes its data based on now playing data. In other words, the XML pull server 628 may obtain the meta data, use it to configure a query (e.g., using the URL), query the video storage 64 (see FIG. 1) for video content, select matching video content from the query results, construct an update including the matching video content, and forward the update to one of the long poll tornado server instances 640, which sends the update to the clients 602. A configuration store (not shown), which is part of the update server 620, contains information about each of the individual audio streams (e.g., the audio feed 62) and incoming meta data received by the update server 620. By way of a non-limiting example, the configuration may include an XML Structure Description (XPATH) for the meta data to be used to parse information received by the FTP server 626, the prophet update server 624, and the XML pull server 628. The XML pull server 628 may also be configured to parse multiple targets (e.g., meta data associated with audio feeds, such as the audio feed 62, and updates received from radio stations, such as the radio station 650) differently based on this configuration. During operation, a scheduling engine manages a priority queue with the priority value being the closest update time, based on song duration and update time. The XML pull server 628 checks the event queue every tick for scheduled updates and runs the scheduled updates. A threaded timer controls delay.

In the embodiment illustrated in FIG. 6, the update server 620 includes the FTP server 626. The FTP Server 626 is configured to accept and recognize pushed content via (the well-established) FTP protocol. The FTP server 626 provides audio sources (e.g., radio stations) more flexibility (or options) for delivering updates to the update server 620. Like the prophet update server 624, when a stream connects and sends meta data to the FTP Server 626, the FTP Server 626 parses the meta data and delegates the lookup to the parent process in the update server 620. Audio sources (e.g., radio stations) attempting to connect to the FTP Server 626 may be required to present credentials before access to the FTP Server 626 is granted by the update server 620. By way of a non-limiting example, the FTP Server 626 may handle input using the FTP protocol from automation systems such as Jazzler.

Those of ordinary skill in the art will appreciate that many possible system architectures for providing matched multimedia video content are possible and that FIG. 6 is a non-limiting example.

### Computing Device

FIG. 7 is a diagram of hardware and an operating environment in conjunction with which implementations of the one or more computing devices of the system 60 (see FIG. 1) and the system 600 (see FIG. 2) may be practiced. The description of FIG. 7 is intended to provide a brief, general description of suitable computer hardware and a suitable computing environment in which implementations may be practiced. For example, implementations are described in the general context of computer-executable instructions, such as program modules, being executed by a computer, such as a personal computer. Generally, program modules include routines, programs, objects, components, data structures, etc., that perform particular tasks or implement particular abstract data types.

Moreover, those of ordinary skill in the art will appreciate that implementations may be practiced with other computer system configurations, including hand-held devices, multiprocessor systems, microprocessor-based or programmable consumer electronics, network PCs, minicomputers, mainframe computers, and the like. Implementations may also be practiced in distributed computing environments where tasks are performed by remote processing devices that are linked through a communications network. In a distributed computing environment, program modules may be located in both local and remote memory storage devices.

The exemplary hardware and operating environment of FIG. 7 includes a general-purpose computing device in the form of the computing device 12. Each of the computing devices of FIGS. 1 and 6 (including the server 66, the client 68, the client 70, each of the clients 602, the long poll redirect server 610, the update server 620, the long poll tornado server instances 640, and the monitoring system 630) may be substantially identical to the computing device 12. Further, the databases 72, 74, and 76 as well as the radio station 650 may each be implemented using one or more computing devices substantially identical to the computing device 12. For example, one or more computing devices like the computing device 12 may transmit the audio feed 62 to the server 66. Optionally, the video storage 64 may be substantially identical to the computing device 12. Alternatively, the video storage 64 may be implemented as a memory device connected to the server 66 or incorporated therein.

By way of non-limiting examples, the computing device 12 may be implemented as a laptop computer, a tablet computer, a web enabled television, a personal digital assistant, a game console, a smartphone, a mobile computing device, a cellular telephone, a desktop personal computer, and the like.

The computing device 12 includes a system memory 22, the processing unit 21, and a system bus 23 that operatively couples various system components, including the system memory 22, to the processing unit 21. There may be only one or there may be more than one processing unit 21, such that the processor of computing device 12 includes a single central-processing unit (“CPU”), or a plurality of processing units, commonly referred to as a parallel processing environment. When multiple processing units are used, the processing units may be heterogeneous. By way of a non-limiting example, such a heterogeneous processing environment may include a conventional CPU, a conventional graphics processing unit (“GPU”), a floating-point unit (“FPU”), combinations thereof, and the like.

The processor 65 (see FIG. 1) may be substantially identical to the processing unit 21. Further, the memory 67 (see FIG. 1) may be substantially identical to the system memory 22.

The computing device 12 may be a conventional computer, a distributed computer, or any other type of computer.

The system bus 23 may be any of several types of bus structures including a memory bus or memory controller, a peripheral bus, and a local bus using any of a variety of bus architectures. The system memory 22 may also be referred to as simply the memory, and includes read only memory (ROM) 24 and random access memory (RAM) 25. A basic input/output system (BIOS) 26, containing the basic routines that help to transfer information between elements within the computing device 12, such as during start-up, is stored in ROM 24. The computing device 12 further includes a hard disk drive 27 for reading from and writing to a hard disk, not shown, a magnetic disk drive 28 for reading from or writing to a removable magnetic disk 29, and an optical disk drive 30 for reading from or writing to a removable optical disk 31 such as a CD ROM, DVD, or other optical media.

The hard disk drive 27, magnetic disk drive 28, and optical disk drive 30 are connected to the system bus 23 by a hard disk drive interface 32, a magnetic disk drive interface 33, and an optical disk drive interface 34, respectively. The drives and their associated computer-readable media provide nonvolatile storage of computer-readable instructions, data structures, program modules, and other data for the computing device 12. It should be appreciated by those of ordinary skill in the art that any type of computer-readable media which can store data that is accessible by a computer, such as magnetic cassettes, flash memory cards, solid state memory devices (“SSD”), USB drives, digital video disks, Bernoulli cartridges, random access memories (RAMs), read only memories (ROMs), and the like, may be used in the exemplary operating environment. As is apparent to those of ordinary skill in the art, the hard disk drive 27 and other forms of computer-readable media (e.g., the removable magnetic disk 29, the removable optical disk 31, flash memory cards, SSD, USB drives, and the like) accessible by the processing unit 21 may be considered components of the system memory 22.

A number of program modules may be stored on the hard disk drive 27, magnetic disk 29, optical disk 31, ROM 24, or RAM 25, including the operating system 35, one or more application programs 36, other program modules 37, and program data 38. A user may enter commands and information into the computing device 12 through input devices such as a keyboard 40 and pointing device 42. Other input devices (not shown) may include a microphone, joystick, game pad, satellite dish, scanner, touch sensitive devices (e.g., a stylus or touch pad), video camera, depth camera, or the like. These and other input devices are often connected to the processing unit 21 through a serial port interface 46 that is coupled to the system bus 23, but may be connected by other interfaces, such as a parallel port, game port, a universal serial bus (USB), or a wireless interface (e.g., a Bluetooth interface). A monitor 47 or other type of display device is also connected to the system bus 23 via an interface, such as a video adapter 48. In addition to the monitor, computers typically include other peripheral output devices (not shown), such as speakers, printers, and haptic devices that provide tactile and/or other types of physical feedback (e.g., a force feed back game controller).

The input devices described above are operable to receive user input and selections. Together the input and display devices may be described as providing a user interface.

The computing device 12 may operate in a networked environment using logical connections to one or more remote computers, such as remote computer 49. These logical connections are achieved by a communication device coupled to or a part of the computing device 12 (as the local computer). Implementations are not limited to a particular type of communications device. The remote computer 49 may be another computer, a server, a router, a network PC, a client, a memory storage device, a peer device or other common network node, and typically includes many or all of the elements described above relative to the computing device 12. The remote computer 49 may be connected to a memory storage device 50. The logical connections depicted in FIG. 7 include a local-area network (LAN) 51 and a wide-area network (WAN) 52. Such networking environments are commonplace in offices, enterprise-wide computer networks, intranets and the Internet.

Those of ordinary skill in the art will appreciate that a LAN may be connected to a WAN via a modem using a carrier signal over a telephone network, cable network, cellular network, or power lines. Such a modem may be connected to the computing device 12 by a network interface (e.g., a serial or other type of port). Further, many laptop computers may connect to a network via a cellular data modem.

When used in a LAN-networking environment, the computing device 12 is connected to the local area network 51 through a network interface or adapter 53, which is one type of communications device. When used in a WAN-networking environment, the computing device 12 typically includes a modem 54, a type of communications device, or any other type of communications device for establishing communications over the wide area network 52, such as the Internet. The modem 54, which may be internal or external, is connected to the system bus 23 via the serial port interface 46. In a networked environment, program modules depicted relative to the personal computing device 12, or portions thereof, may be stored in the remote computer 49 and/or the remote memory storage device 50. It is appreciated that the network connections shown are exemplary and other means of and communications devices for establishing a communications link between the computers may be used.

The computing device 12 and related components have been presented herein by way of particular example and also by abstraction in order to facilitate a high-level view of the concepts disclosed. The actual technical design and implementation may vary based on particular implementation while maintaining the overall nature of the concepts disclosed.

In some embodiments, the system memory 22 stores computer executable instructions that when executed by one or more processors cause the one or more processors to perform all or portions of one or more of the methods (including the method 200 illustrated in FIGS. 3A and 3B and the method 400 illustrated in FIG. 4) described above. Such instructions may be stored on one or more non-transitory computer-readable media.

In some embodiments, the system memory 22 stores computer executable instructions that when executed by one or more processors cause the one or more processors to generate the client display screen (e.g., the webpage 100 illustrated in FIG. 2) described above. Such instructions may be stored on one or more non-transitory computer-readable media.

Reference in the specification to “one embodiment” or to “an embodiment” means that a particular feature, structure, or characteristic described in connection with the embodiments is included in at least one embodiment. The appearances of the phrase “in one embodiment” or “an embodiment” in various places in the specification are not necessarily all referring to the same embodiment.

The algorithms and displays presented herein are not inherently related to any particular computer or other apparatus. Various general-purpose systems may also be used with programs in accordance with the teachings herein, or it may prove convenient to construct more specialized apparatus to perform the method steps. The structure for a variety of these systems will appear from the description herein. In addition, the embodiments are not described with reference to any particular programming language. It will be appreciated that a variety of programming languages may be used to implement the teachings of the embodiments as described herein, and any references herein to specific languages are provided for disclosure of enablement and best mode.

In addition, the language used in the specification has been principally selected for readability and instructional purposes, and may not have been selected to delineate or circumscribe the inventive subject matter. Accordingly, the disclosure of the embodiments is intended to be illustrative, but not limiting, of the scope of the embodiments.

While particular embodiments and applications have been illustrated and described herein, it is to be understood that the embodiments are not limited to the precise construction and components disclosed herein and that various modifications, changes, and variations may be made in the arrangement, operation, and details of the methods and apparatuses of the embodiments without departing from the spirit and scope of the embodiments.

The foregoing described embodiments depict different components contained within, or connected with, different other components. It is to be understood that such depicted architectures are merely exemplary, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected,” or “operably coupled,” to each other to achieve the desired functionality.

While particular embodiments of the present invention have been shown and described, it will be obvious to those skilled in the art that, based upon the teachings herein, changes and modifications may be made without departing from this invention and its broader aspects and, therefore, the appended claims are to encompass within their scope all such changes and modifications as are within the true spirit and scope of this invention. Furthermore, it is to be understood that the invention is solely defined by the appended claims. It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to inventions containing only one such recitation, even when the same claim includes the introductory phrases “one or more” or “at least one” and indefinite articles such as “a” or “an” (e.g., “a” and/or “an” should typically be interpreted to mean “at least one” or “one or more”); the same holds true for the use of definite articles used to introduce claim recitations. In addition, even if a specific number of an introduced claim recitation is explicitly recited, those skilled in the art will recognize that such recitation should typically be interpreted to mean at least the recited number (e.g., the bare recitation of “two recitations,” without other modifiers, typically means at least two recitations, or two or more recitations).

Accordingly, the invention is not limited except as by the appended claims.

The invention claimed is:

1. A method of providing content to a client computing device configured to present the content to a user, the method being performed by one or more computing devices connected to the client computing device, the method comprising:
receiving an audio feed having audio segments, each of the audio segments including either regular audio content or preemptory audio content;
determining whether each of the audio segments includes regular audio content or preemptory audio content;
for each of the audio segments determined to include preemptory audio content, directing the client computing device to preempt, with the preemptory audio content, any current content being presented by the client computing device; and
for each of the audio segments determined to include regular audio content, identifying the regular audio content, matching multimedia video content with the identified regular audio content, and directing the matched multimedia video content to the client computing device for presentation thereby to the user.

2. The method of claim 1, wherein identifying the regular audio content comprises parsing meta data from the regular audio content.

3. The method of claim 2, wherein identifying the regular audio content further comprises disambiguating that meta data to obtain a unique representation of the regular audio content.

4. The method of claim 3, wherein identifying the regular audio content further comprises identifying an audio object by searching an audio database for the unique representation of the regular audio content.

5. The method of claim 4, wherein matching multimedia video content with the identified regular audio content comprises searching a video storage for one or more multimedia video content objects that match the audio object, the one or more multimedia video content objects comprising the multimedia video content.

6. The method of claim 5, further comprising filtering the one or more multimedia video content objects to obtain the multimedia video content.

7. The method of claim 5, further comprising assigning a weight to each of the one or more multimedia video content objects; and
selecting one of the one or more multimedia video content objects as the multimedia video content based on the weight assigned to each of the one or more multimedia video content objects.

8. The method of claim 7, wherein the weight assigned to each of the one or more multimedia video content objects is determined at least in part based on user feedback.

9. The method of claim 1, wherein the audio feed is received from a radio station, and identifying the regular audio content comprises receiving identifying information from the radio station, or parsing now playing information provided by a secondary source that is time synced with the audio feed.

10. The method of claim 1, wherein identifying the regular audio content comprises performing a fingerprinting operation on the regular audio content.

11. The method of claim 10, wherein performing the fingerprinting operation on the regular audio content comprises performing a Sim-Hash algorithm on the regular audio content.

12. The method of claim 1, further comprising:
when the matched multimedia video content is explicit content, requiring a confirmation from the client computing device before directing the matched multimedia video content to the client computing device.

13. The method of claim 1, wherein determining whether each of the audio segments includes regular audio content or preemptory audio content comprises attempting to identify audio content included in the audio segment, and determining the audio segment includes preemptory audio content if the attempt to identify the audio content is unsuccessful.

14. The method of claim 1, wherein the audio feed is received from an audio source, and determining whether each of the audio segments includes regular audio content or preemptory audio content comprises receiving an indicator from the audio source indicating whether the audio segment includes regular audio content or preemptory audio content.

15. A system for use with a plurality of client computing devices each configured to display audio and video content, the system comprising:
at least one update server computing device configured to receive an audio feed comprising audio segments, match at least a portion of the audio segments with video content, and construct an update for each of the audio segments, each update comprising the video content, if any, matched with the audio segment associated with the update; and
at least one communication server computing device connected to the plurality of client computing devices and the at least one update server computing device, the at least one communication server computing device being configured to receive the updates, and direct the updates to the plurality of client computing devices.

16. The system of claim 15, wherein the at least one communication server computing device comprises a plurality of communication server computing devices, and the system further comprises:
at least one long poll redirect server computing device configured to receive long poll requests from the plurality of client computing devices, and direct each of the requests to a selected one of the plurality of communication server computing devices, the requests indicating that the client computing devices would like to continue receiving updates.

17. A method for use with a server computing device and an audio stream received by the server computing device, the method comprising:
playing, by a client computing device connected to the server computing device, current content comprising either current video content or current audio only content;
while the current content is playing, receiving, by the client computing device, a first update from the server, the first update indicating whether first video content has been matched to first audio content in the audio stream; and
when the first update indicates that first video content has been matched to the first audio content, determining, by the client computing device, whether to preempt the current content with the first video content or wait to play the first video content until after the current content has finished playing.

18. The method of claim 17, further comprising:
when the first update indicates that first video content has not been matched to the first audio content, selecting, by the client computing device, a live content stream comprising live content, and playing the live content of the live content stream.

19. The method of claim 18, further comprising:
after starting to play the live content, receiving, by the client computing device, a second update from the server, the second update indicating a second video content has been matched to second audio content in the audio stream; and
preempting, by the client computing device, the live content with the second video content.

20. The method of claim 17, further comprising:
while playing the first video content, receiving, by the client computing device, a second update from the server, the second update indicating a second video content has been matched to second audio content in the audio stream; and
waiting to play the second video content until after the first video content has finished playing.

21. The method of claim 17, further comprising:
while playing the first video content, receiving, by the client computing device, a second update from the server, the second update indicating a second video content has not been matched to second audio content in the audio stream; and
preempting, by the client computing device, the first video content with the second audio content.

22. The method of claim 21, wherein the second audio content is a commercial.

23. The method of claim 17, further comprising:
receiving, by the client computing device, an indication that a first user operating the client computing device would like to share the first video content with a second user operating a different client computing device; and
sending a link to the first video content to the different client computing device that when selected by the second user causes the different computing device to play the first video content and begin receiving updates from the server computing device based on the audio feed.
